(19) United States
(12) Patent Application Publication
(10) Pub. No.: US 2020/0194987 A1
(43) Pub. Date: Jun. 18, 2020

(54) NON-ADHESIVE CABLE CLIP AND ELECTRONIC DEVICE USING SAME

(71) Applicants: HONG FU JIN PRECISION INDUSTRY (WuHan) CO., LTD., Wuhan (CN); HON HAI PRECISION INDUSTRY CO., LTD., New Taipei (TW)

(72) Inventors: CHUN-BAO GU, Wuhan (CN); WEN-HSIANG HUNG, New Taipei (TW)

(21) Appl. No.: 16/438,651

(22) Filed: Jun. 12, 2019

(30) Foreign Application Priority Data
Dec. 18, 2018 (CN) 201811549795.6

(51) Int. Cl. H02G 3/32; F16L 3/13; F16L 3/137

(52) U.S. Cl. CPC H02G 3/32; F16L 3/137; F16L 3/13

(57) ABSTRACT

A cable clip for fixing cables which is adjustable as to size and is not adhesively adhered to a casing includes a cable bundling portion, a fitting portion, and a seat. The cable bundling portion and the fitting portion are fixed on opposite sides of the seat. The cable bundling portion defines a receiving space for one or more cables and includes a rack and an engaging arm. The rack comprises a fixed portion and an engaging portion both formed on an outer surface of the rack. The fixing portion fixes the rack to the seat. The engaging portion comprises meshing teeth one of which can engage with the engaging arm to adjust a size of the receiving space. An electronic device using such a cable clip is also provided.

### FIELD

The subject matter herein generally relates to cable clips.

### BACKGROUND

Cable clips for electronic devices are adhered to the cases of the electronic devices. However, the adhesive cable clips are difficult to be disassembled from the cases of the electronic devices when the cable clip is broken or needs replacing. Furthermore, the cable clips can easily peel off as the adhesive adhering the cable clips to the cases is aged over time. Further, sizes of existing cable clips are not adjustable and result in inconvenience in adding more cables in a cable clip.

Therefore, there is room for improvement.

### BRIEF DESCRIPTION OF THE DRAWINGS

Implementations of the present technology will now be described, by way of embodiments, with reference to the attached figures.

FIG. 1 is an isometric view of a cable clip according to an embodiment of the present disclosure.

FIG. 2 is an isometric view of the cable clip of FIG. 1 from another angle.

FIG. 3 is an isometric view of the cable clip of FIG. 1 mounted on a casing.

FIG. 4 is a flow chart of a method for assembling the cable clip of FIG. 1 according to an embodiment of the present disclosure.

FIG. 5 is a flow chart of a method for disassembling the cable clip of FIG. 1 according to an embodiment of the present disclosure.

### DETAILED DESCRIPTION

The present disclosure is made in conjunction with the accompanying drawings. Specific embodiments of the present disclosure are described.

In the following description, when an element is described as being “fixed to” another element, the element can be fixed to the another element with or without intermediate elements. When an element is described as “connecting” another element, the element can be connected to the other element with or without intermediate elements.

Without a given definition otherwise, all terms used have the same meaning as commonly understood by those skilled in the art. The term “and/or” means including any and all combinations of one or more of associated listed items.

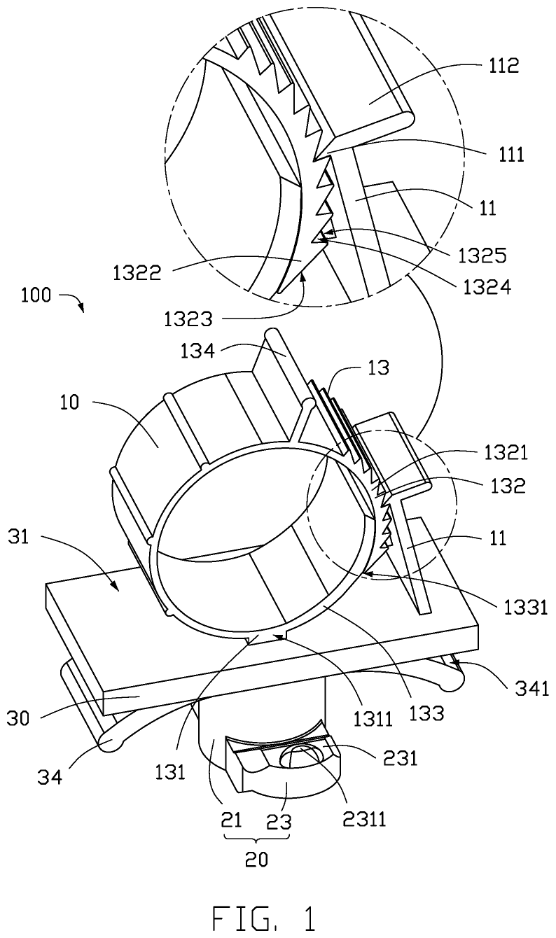

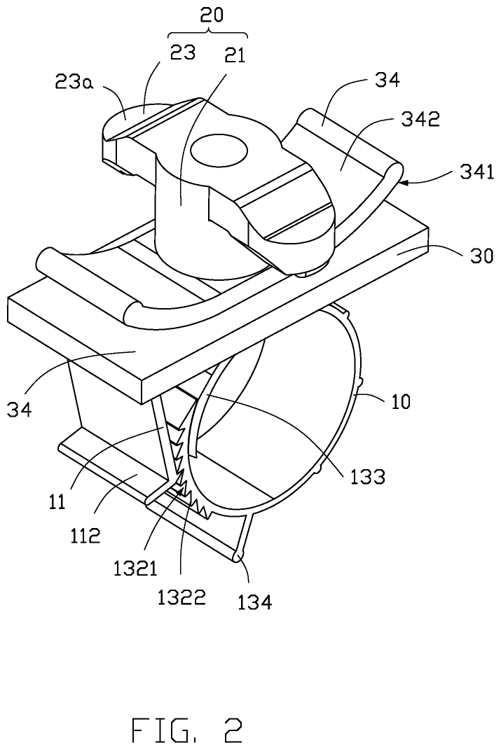

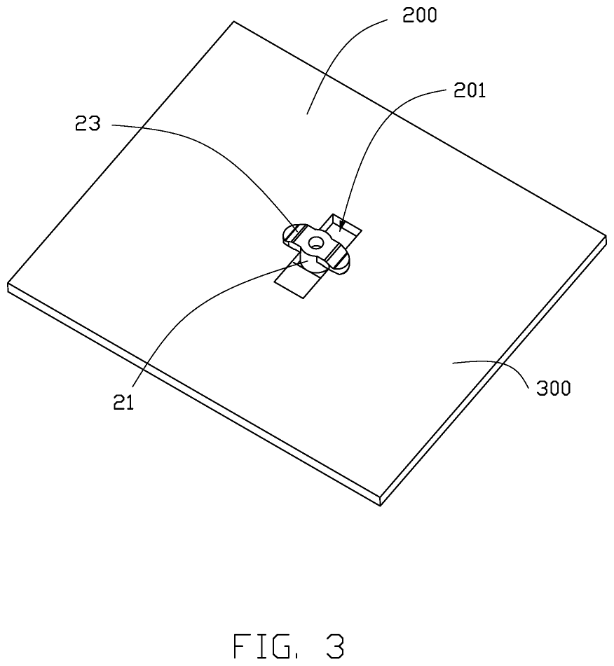

Referring to FIGS. 1 and 2, a cable clip 100 is used for fixing cables (not shown) to a casing or other object (object 200, see in FIG. 3). The cable clip 100 includes a cable bundling portion 10, a fitting portion 20, and a seat 30. The cable bundling portion 10 and the fitting portion 20 are fixed to opposite sides of the seat 30.

The seat 30 substantially has shape of a rectangular parallelepiped and includes a first surface 31 and a second surface 33 opposite to the first surface 31. The cable bundling portion 10 is fixed on the first surface 31, and the fitting portion 20 is fixed on the second surface 33.

The cable bundling portion 10 defines a receiving space 15 for receiving the cables. The cable bundling portion 10 includes a rack 13 and an engaging arm 11. The rack 13 has a first inner surface 132 and a first outer surface 131 opposite to the first inner surface 132. The rack 13 includes a fixing portion 133 and an engaging portion 134. The fixing portion 133 is formed on the first outer surface 131 and fixes the rack 13 to the seat 30. The engaging portion 134 is also formed on the first outer surface 131 and includes a plurality of meshing teeth 1312. The engaging arm 11 can engage with one of the engaging teeth 1312, and thereby a size of the receiving space 15 is adjusted.

In the embodiment, the engaging arm 11 includes a hook 111, a main body 113, and a first pulling member 112. The main body 113 has an end fixed to the first surface 31 of the seat 30 and another end on which there is the hook 111 and the first pulling member 112 The hook 111 faces the rack 13 and meshes with one of the meshing teeth 1312. The first pulling member 112 is opposite to the hook 111 and extends away from the hook 111. A user can pull on the first pulling member 112 to move the engaging arm 11 away from the rack 13, so that the engaging arm 11 is disengaged from the meshing teeth 1312. Meanwhile, the user can adjust a position of the meshing teeth 1312, thereby adjusting a relative position of the rack 13 relative to the hook 111 and selecting one tooth of the meshing teeth 1312 to mesh with the hook 111. The rack 13 further includes a second pulling member 136 disposed on the first outer surface 131. The second pulling member 136 is provided for the user to push and slide the engaging portion 134 relative to the hook 111 to change one of the meshing teeth 1312 to mesh with the hook 111, thereby adjusting the size of the receiving space 15.

In the embodiment, the engaging arm 11 is a resilient sheet-like structure. When the user releases the first pulling member 112, the hook 111 will automatically return to its initial position and engage with the one of the meshing teeth 1312 aligned with it.

In the embodiment, the fixing portion 133 comprises a protrusion 1311 formed on the first outer surface 131. The rack 13 is fixed to the first surface 31 of the seat 30 by the protrusion 1311. in the embodiment, the rack 13 is fixed on a central part of the first surface 31 of the seat 30 by the protrusion 1311.

Each of the meshing teeth 1312 is substantially wedge-shaped, each tooth having a third surface 1323 and a fourth surface 1324 both having an end connected to the first outer surface 131. The third surface 1323 has an opposite end connected to an opposite end of the fourth surface 1324. An accommodating groove 1325 is formed between neighboring teeth of the meshing teeth 1312. The hook 111 can be received in any one accommodating groove 1325 to engage with the rack 13. As the hook 111 can be received in different accommodating grooves 1325, the size of the cable bundling portion 10 is adjusted accordingly.

In the embodiment, the rack 13 further includes a bearing portion 135 extended from the protrusion 1311 toward the hook 111, the bearing portion 135 abuts against the first inner surface 132. A ring structure is thereby formed by the rack 13, the ring structure enclosing the receiving space 15. In another embodiment, the bearing portion 135 can be omitted.

The fitting portion 20 includes a rotatable body 21 and a latching unit 23 including a pair of latching members 23a. The rotatable body 21 has an end rotatably fixed to the second surface 33 of the seat 30, and an opposite end formed with the latching members 23a. The latching members 23a are symmetrical about the rotatable body 21.

The rotatable body 21 is rotatably fixed to the seat 30 by a rotating shaft (not shown). A size of the latching unit 23 is smaller than a size of the seat 30.

In the embodiment, an elastic piece 34 is mounted on the second surface 33 of the seat 30. The elastic piece 34 is an arc-shaped structure. The elastic piece 34 is curved away from the second surface 33 and has a second inner surface 341 away from the second surface 33 and a second outer surface 342 facing the second surface 33. The second outer surface 342 of the elastic piece 34 is fixed to the second surface 33. The elastic piece 34 defines a through hole (not shown). One end of the rotatable body 21 passes through the through hole and is fixed to the seat 30, thereby the elastic piece 34 is located between the seat 30 and the latching members 23.

Referring to FIG. 3, the object 200 may be a case of a portable electronic device 300 such as a mobile phone, a tablet computer, a notebook computer, a desktop computer or a television. The object 200 may also be a case of a machine. The object 200 includes a mounting hole 201 defined in a flat portion of the object 200. The mounting hole 201 extends through two opposite surfaces of the object 200. The mounting hole 201 has a size larger than the size of the latching unit 23 and smaller than the size of the seat 30, thereby the mounting hole 201 allows the latching unit 23 to pass through while preventing the seat body 30 from passing through. After the latching unit 23 passes through the mounting hole 201, the latching members 23a can be rotated to fix the cable clip 100 on the object 200. The flat portion of the object 200 is thereby sandwiched between the latching unit 23 and the elastic piece 34. In the embodiment, the latching unit 23 has a fifth surface 231 facing the seat 30. A convex bulge 2311 is formed on the fifth surface 231. The convex bulge 2311 is made of an elastic material and for abutting against the object 200 while facilitating the rotation of the rotatable body 21.

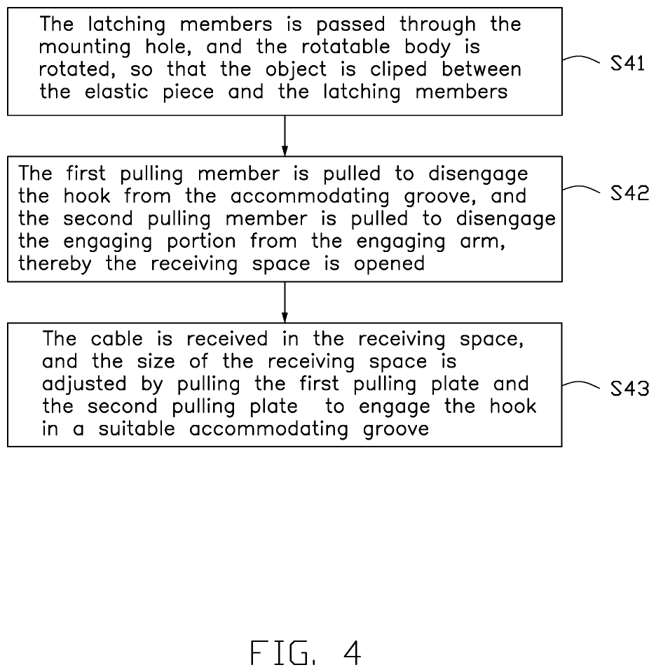

Referring to FIG. 4, a method for assembling a cable clip 100 on an object 200 having a mounting hole 201 according to an embodiment includes the following steps. In step S41, the latching unit 23 is passed through the mounting hole 201, and the rotatable body 21 is rotated, so that the flat portion of the object 200 is clipped between the elastic piece 34 and the latching member 23. In step S42, the first pulling member 112 is pulled to disengage the hook 111 from the accommodating groove 1325, and the second pulling member 136 is pulled to disengage the engaging portion 134 from the engaging arm 11. The receiving space 15 is thereby opened to receive cables. In step S43, the cables are received in the receiving space 15, and the size of the receiving space 15 is adjusted by pulling the first pulling plate 112 and the second pulling plate 136 to engage the hook 111 in a suitable accommodating groove 1325.

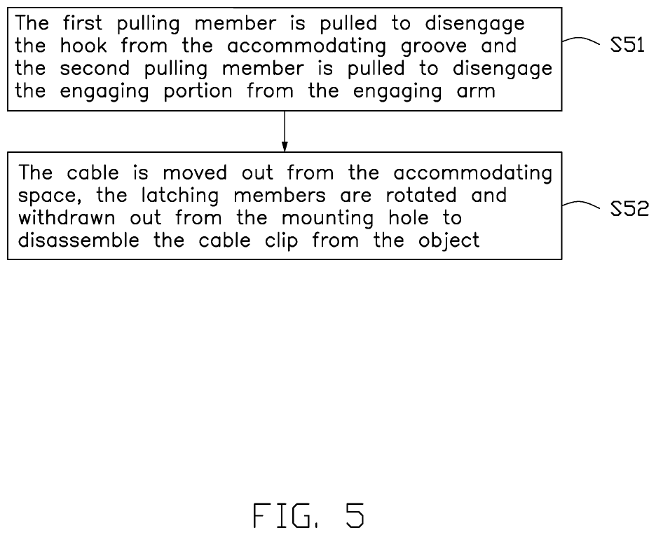

Referring to FIG. 5, when the cables need to be detached from the cable clip 100, a method of disassembling the cables and the cable clip 100 from the object 200 according to an embodiment include the following steps.

In step S51, the first pulling member 112 is pulled to disengage the hook 111 from the accommodating groove 1325 and the second pulling member 136 is pulled to disengage the engaging portion 134 from the engaging arm 11.

In step S52, the cables are moved out from the accommodating space 15, the latching members 23 are rotated and withdrawn from the mounting hole 201 to disassemble the cable clip 100 from the object 200.

The embodiments shown and described above are only examples. Even though numerous characteristics and advantages of the present technology have been set forth in the foregoing description, together with details of the structure and function of the present disclosure, the disclosure is illustrative only, and changes can be made in the detail, including in matters of shape, size, and arrangement of the parts within the principles of the present disclosure, up to and including the full extent established by the broad general meaning of the terms used in the claims.

What is claimed is:

1. A non-adhesive cable clip for fixing cables, comprising a cable bundling portion, a fitting portion and a seat, wherein the cable bundling portion and the fitting portion are respectively fixed on two opposite sides of the seat, the cable bundling portion defines a receiving space for receiving the cables and comprises a rack and an engaging arm, the rack comprises a first inner surface and a first outer surface opposite to the first inner surface, the rack comprises a fixed portion and an engaging portion both formed on the first outer surface, the fixing portion fixes the rack to the seat, the engaging portion comprises a plurality of meshing teeth, each of the meshing teeth is selectable for engaging with the engaging arm to adjust a size of the receiving space.

2. The cable clip as claimed in claim 1, wherein the fitting portion comprises a rotatable body and a latching unit comprising a pair of latching members, the rotatable body has an end rotatably fixed to the seat and an opposite end formed with the latching unit.

3. The cable clip as claimed in claim 2, wherein the seat comprises a first surface and a second surface opposite to the first surface, the cable bundling portion is fixed on the first surface and the fitting portion is fixed on the second surface.

4. The cable clip as claimed in claim 3, wherein the engaging arm comprises a hook, a main body and a first pulling member, the main body has an end fixed to the first surface of the seat and an opposite end formed with the hook and the first pulling member, the hook faces the rack and is engagable with any one of the meshing teeth, the first pulling member extends away from the hook and is movable to move the engaging arm away from the rack.

5. The cable clip as claimed in claim 4, wherein the rack comprises a protrusion fixing the rack to the first surface of the seat.

6. The cable clip as claimed in claim 4, wherein each of the meshing teeth is substantially wedge-shaped, an accommodating groove is formed between neighboring teeth of the meshing teeth for receiving the hook and engaging the hook with the rack.

7. The cable clip as claimed in claim 4, wherein the rack further comprises a bearing portion extended from the fixing portion toward the hook, the bearing portion abuts against the first inner surface of the rack, a ring structure is thereby formed by the rack, the ring structure enclosing the receiving space.

8. The cable clip as claimed in claim 4, wherein the rack further comprises a second pulling member formed on the first outer surface of the rack and movable to slide the engaging portion relative to the hook to select one tooth of the meshing teeth to mesh with the hook, thereby adjusting the size of the receiving space.

9. The cable clip as claimed in claim 2, wherein the cable clip further comprises an elastic piece of arc-shaped, the elastic piece is curved away from the second surface of the seat and defines a through hole, one end of the rotatable body passes through the through hole and is fixed to the seat.

10. An electronic device comprising a non-adhesive cable clip for fixing cables and an object defining a mounting hole for mounting the cable clip, wherein the cable clip comprises a cable bundling portion, a fitting portion and a seat, the cable bundling portion and the fitting portion are respectively fixed on two opposite sides of the seat, the cable bundling portion defines a receiving space for receiving the cables and comprises a rack and an engaging arm, the rack comprises a first inner surface and a first outer surface opposite to the first inner surface, the rack comprises a fixed portion and an engaging portion both formed on the first outer surface, the fixing portion fixes the rack to the seat, the engaging portion comprises a plurality of meshing teeth, each of the meshing teeth is selectable for engaging with the engaging arm to adjust a size of the receiving space. the fitting portion comprises a rotatable body and a latching unit comprising a pair of latching members, the rotatable body has an end rotatably fixed to the seat and an opposite end formed with the latching unit, the latching members passes through the mounting hole to sandwich the object between the latching members and the seat.

11. The electronic device as claimed in claim 10, wherein the seat comprises a first surface and a second surface opposite to the first surface, the cable bundling portion is fixed on the first surface and the fitting portion is fixed on the second surface.

12. The electronic device as claimed in claim 11, wherein the engaging arm comprises a hook, a main body and a first pulling member, the main body has an end fixed to the first surface of the seat and an opposite end formed with the hook and the first pulling member, the hook faces the rack and is engagable with any one of the meshing teeth, the first pulling member extends away from the hook and is movable to move the engaging arm away from the rack.

13. The electronic device as claimed in claim 12, wherein the rack comprises a protrusion fixing the rack to the first surface of the seat.

14. The electronic device as claimed in claim 12, wherein each of the meshing teeth is substantially wedge-shaped, an accommodating groove is formed between neighboring teeth of the meshing teeth for receiving the hook and engaging the hook with the rack.

15. The electronic device as claimed in claim 12, wherein the rack further comprises a bearing portion extended from the fixing portion toward the hook, the bearing portion abuts against the first inner surface of the rack, a ring structure is thereby formed by the rack, the ring structure enclosing the receiving space.

16. The electronic device as claimed in claim 12, wherein the rack further comprises a second pulling member formed on the first outer surface of the rack and movable to slide the engaging portion relative to the hook to select one tooth of the meshing teeth to mesh with the hook, thereby adjusting the size of the receiving space.

17. The electronic device as claimed in claim 10, wherein the cable clip further comprises an elastic piece of arc-shaped, the elastic piece is curved away from the second surface of the seat and defines a through hole, one end of the rotatable body passes through the through hole and is fixed to the seat.
